(19) United States
(12) Patent Application Publication
(10) Pub. No.: US 2013/0277071 A1
(43) Pub. Date: Oct. 24, 2013

(54) METHOD AND DEVICE FOR FIGHTING OR PREVENTING FIRES IN THE INTERIOR, ON THE SURFACE, OR IN THE SURROUNDINGS OF AN ELECTROCHEMICAL ENERGY STORE

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/884,242

(22) PCT Filed: Oct. 28, 2011
(86) PCT No.: PCT/EP2011/005475

§ 371 Date: Jun. 11, 2013

(30) Foreign Application Priority Data
Nov. 8, 2010 (DE) 10 2010 050 742.3

(51) Int. Cl. A62C 3/16; A62C 99/00; A62C 37/00

(52) U.S. Cl. CPC A62C 3/16; A62C 37/00; A62C 99/0018
USPC 169/43; 169/70; 169/60

(57) ABSTRACT

In a method or in a device for fighting or preventing fires in the interior, on the surface, or in the surroundings of an electrochemical energy store, a unit is provided which ensures that the concentration of an inert gas or of a mixture of inert gases in the interior, on the surface, or in the surroundings of the electrochemical energy store does not fall below a predetermined value.

The present invention relates to a method and device for fighting or preventing fires in the interior, on the surface, or in the surroundings of an electrochemical energy store.

Fires associated with electrochemical energy stores, particularly associated with lithium-based electrochemical energy store, represent a significant challenge for personnel who must confront or are appointed to combat or prevent such fires, including for example manufacturers, retailers or emergency services.

The present invention is based on the object of suggesting a method and a device for fighting or preventing fires in the interior, on the surface or in the surroundings of an electrochemical energy store, which enables such fires to be fought or prevented reliably while at the same time minimising damage. This object is solved by a method or a device according to any of the independent claims. The subordinate claims are designed to obtain protection for advantageous refinements of the invention.

According to the invention, a method is provided for fighting or preventing fires in the interior, on the surface or in the surroundings of an electrochemical energy store, in which a device preferably functions to ensure that the concentration of an inert gas or a mixture of inert gases does not fall below a predetermined value in the interior, on the surface or in the surroundings of an electrochemical energy store.

Also according to the invention, an apparatus is provided for fighting or preventing fires in the interior, on the surface or in the surroundings of an electrochemical energy store that preferably includes a device whose function is to ensure that the concentration of an inert gas or a mixture of inert gases does not fall below a predetermined value in the interior, on the surface or in the surroundings of an electrochemical energy store.

In this context, an inert gas is understood to be a gas or mixture of gases that is suitable for preventing or fighting a fire, preferably because the inert gas displaces or eliminates a chemical reaction partner, the presence of which is favourable or essential to the start or continued existence of the fire. Preferred examples of such inert gases are argon, nitrogen, carbon dioxide or mixtures of more than one of such gases, such as Inergen® or Argonite®.

In general, all gases that do not react chemically with the burning material and are capable of forcing possible reaction partners for the burning material out of the area of the fire are suitable for use as inert gases in this context. Inergen® is a brand name for a mixture of nitrogen, argon and carbon dioxide that is used as an extinguishing agent in firefighting or as a barrier gas in active fire prevention. The chemical composition of Inergen is 52% by volume nitrogen, 40% by volume argon and 8% by volume carbon dioxide (http://de.wikipedia.org/wiki/lnergen).

All of the components of INERGEN®—argon, nitrogen and carbon dioxide—are of natural origin. Argon and nitrogen are obtained from the ambient atmosphere, carbon dioxide is recovered from natural gas sources. After the fire has been extinguished, they escape unchanged back into the atmosphere without polluting the environment. INERGEN® suffocates fire by forcing oxygen out of the site, and at the same time the carbon dioxide component ensures that the human body is supplied with oxygen.

The 8% by volume content of CO2 in the extinguishing agent yields a concentration of 2.5-5.0% by volume in the saturated space depending on the risk of fire and the quantity of extinguishing agent. This low percentage affects the respiration control in the human body, with the result that the reduced oxygen supply in the extinguishing range—reduced to 14% by volume to 10% by volume for extinguishing a fire—is compensated by an automatic increase in breathing rate (volume). The quantity of oxygen that is supplied to our brain cells to ensure the maintenance of vital body functions remains practically unchanged, even for individuals who are unconscious. INERGEN® is thus a gas extinguishing agent that does not harm the human organism. It extinguishes fires entirely without residue and is one hundred percent environmentally neutral (http://www.totalwalther.de/inergen_loeschanlagen.htm).

The noble gas argon has a density of 1.784 kg/cm³ at 0° C. and 1013 hPa, and is thus heavier than air. It is chemically very inert, it is the cheapest of the noble gases and available in large quantities, so it is used in many industrial applications. Argon used for preference as a protective gas when nitrogen cannot be used as the protective gas, for example in processes with metals that react chemically with nitrogen at high temperatures. Argon is not poisonous and is even used as a foodstuff additive (E938) as a propellant and protective gas preferably in packaging foods and in winemaking. Because of its suffocating effect, argon can be used as a gas-phase extinguishing agent and is used mainly to protect objects, particularly in electrical and computing systems (http://de.wikipedia.org/wiki/Argon).

Nitrogen is a colourless, non-poisonous gas, heavier than air with a density of 1.250 kg/cm³ at 0° C. and which boils at 77.36 Kelvin. Molecular nitrogen constitutes 78% of the naturally breathable atmosphere, and is thus the major component thereof. Like argon, nitrogen is also approved for use as a foodstuffs additive, for example as a propellant, packaging gas or a gas for whipping cream when it has the designator E941. Nitrogen is used as a shielding gas in welding and other applications, and as a lamp filler gas. The inert properties of nitrogen render it highly suitable for these applications (http://de.wikipedia.org/wiki/Stickstoff).

Carbon dioxide is a colourless and odourless gas that dissolves readily in water but is non-combustible, and only decomposes above a temperature of 2,000° C. to yield carbon monoxide and oxygen. With basic metal oxides or metal hydroxides if forms two types of salts, which are called carbonates and hydrogencarbonates (http://de.wikipedia.org/wiki/Kohlenstoffdioxid). Carbon dioxide is a natural component of breathable air, where it occurs in an average concentration of 0.038%. Because of its oxygen displacing property, carbon dioxide is used for fire extinguishing purposes, particularly in handheld fire extinguishers and automatic extinguishing systems.

As a component of the inert gas Inergen®, carbon dioxide also lends Inergen the capability to be used in firefighting and fire prevention in rooms frequented by humans. In these circumstances, carbon dioxide has the effect of increasing a person's breathing frequency in low-oxygen environments, so that people in rooms flooded with Inergen can survive in oxygen concentrations of barely more than 10% by volume. Since many fires are unable to continue burning or even start when oxygen concentrations are so low, fire prevention or firefighting arrangements based on Inergen are often to be preferred to firefighting arrangements with other protective gases, because the former may actively help to reduce the threat to persons involved.

Argonite® is a brand name for a mixture consisting of about 50% argon and 50% nitrogen. Unlike Inergen, Argonite does not contain any added carbon dioxide, which means that the possibly life-preserving effects of the carbon dioxide additive in Inergen are not present when Argonite is used, which however is associated with the occasionally advantageous consequence in that undesirable effects on living beings or chemical reactions with a carbon dioxide admixture are not to be anticipated when Argonite is used.

Besides the inert gases described in the preceding such as argon or nitrogen or mixtures thereof such as Inergen or Argonite, which may sometimes include admixtures that preferably contain carbon dioxide, other compounds that are usually gaseous under normal conditions may also be considered as inert gases for the purposes of the present invention, and also have flame-suppressing, flame preventing or flame stifling effects.

Such substances also include for example fluoroform or similar haloforms in which the fluorine component is replaced by another halogen. Fluoroform has chemical formula CHF₃ and is used as a fire extinguishing agent in various applications, for which it seems to be well suited by virtue of its generally low toxicity, extremely low chemical reactivity and its high density. Fluoroform is available commercially and is manufactured by DuPont under the trade name FE-13.

Another inert gas that is relevant in the context of the present invention is the inert gas 1,1,1,2,3,3,3-heptafluoropropane, which is also known by the trade name HFC-20720 or HFC-227ea. This is an odourless, colourless, gas-phase halocarbon. This compound is commonly used as a gas-phase fire extinguishing agent. It is most suitable for fighting fires in areas that house data processing and telecommunication systems. Its extinguishing action is most effective at concentrations between 6.25% by volume and 9% by volume. Below a concentration of 9% by volume, the US Environmental Protection Agency allows this gas to be used in rooms used by humans as well. However, at very high temperatures heptanefluoropropane decomposes to form hydrogen fluoride.

Another compound that may be used as an inert gas in the context of the present invention is bromotrifluoromethane. Bromotrifluoromethane suffocates fires in concentrations as low as 6%.

Bromochlorodifluoromethane, known by the trade name Halon 1211, is another compound that may be used in the context of the present invention.

Since some of the halogen-containing compounds listed raise concerns because of their environmentally harmful effects, and the used of some of which is subject to legal restrictions, one more compound should be cited here, which is known by the trade name Novec 1230. This is a product manufactured by 3M. Novec 1230 has a density of 1.723 g/cm³; this means that the gas is heavier than air. The compound is liquid under normal conditions, which is why it can be introduced into the region of the fire in liquid form.

Other gas-phase or liquid compounds, which cannot be cited exhaustively here for reasons of space, are suitable for use as inert gases or components of inert gas mixtures in the context of the present invention.

According to a preferred embodiment of the invention, a method and corresponding device is provided, wherein the device comprises at least one sensor that measures the concentration of at least one inert gas. The device preferably also has at least one control unit, to which the measured values from the at least one sensor are fed. The device also comprises a gas feed device that is controlled by the control unit, and projects an inert gas or mixture of inert gases in the interior, on the surface or in the surroundings of the electrochemical energy store.

The measurement of the concentration of at least one inert gas is potentially beneficial in that the embodiments of the invention that include this feature may also be used effectively in cases where it is not possible or practical to measure the concentration of a gas-phase reaction partner, such as oxygen, for example because oxygen is not the only possible reaction partner in a combustion reaction. In some preferred embodiments of the invention, provision is also made for measuring at least one concentration of a gas-phase reaction partner (educt) in at least one possibly fire-promoting or sustaining chemical reaction as well as measuring the concentration of at least one inert gas. In this way, it is possible to control the flooding of the fire area even better, which in turn may preferably help to alleviate harmful effects on the health of individuals in the area of the fire.

According to another preferred embodiment of the invention, the features of which may also be combined with features of other embodiments, an inert gas from the group consisting of argon, nitrogen, carbon dioxide or a mixture of at least two gases from this group is used in the context of the method or device according to the invention. In other preferred embodiments of the invention, provision is also made for a mixture of one or more gases from this group with at least one additional gas that does not belong to this group instead of a mixture consisting of at least two gases from this group.

According to another preferred embodiment of the invention, the features of which may also be combined with features of other embodiments, it is provided that a flow of the gases is generated or maintained at least temporarily in the interior, on the surface, or in the surroundings of an electrochemical energy store and helps to intermix these gases. These embodiments of the invention are also associated with the advantage that the gas concentrations, particularly the concentrations of the inert gases or other gases of which the concentration is measured, may be kept at uniform or approximately uniform values in different areas in the interior, on the surface, or in the surroundings of the electrochemical energy store. Consequently, the number of gas sensors requirement can be kept low, since the homogeneneity of the gas concentrations means that just a few measurements are representative of the concentration throughout the entire area of the electrochemical energy store.

Such gas streams are preferably generated or maintained by fans that are provided in the interior, on the surface, or in the surroundings of the electrochemical energy store.

In a further preferred embodiment of the invention, the features of which may also be combined with features of other embodiments, it is provided that a negative pressure is generated or maintained at least temporarily in the interior, on the surface, or in the surroundings of the electrochemical energy store by extracting gases. Temporary extraction of gases of this kind may help to accelerate the displacement or elimination of participants in chemical reactions that might encourage, sustain or accelerate combustion, thereby counteracting the fire. Moreover, the negative pressure that is created after gases have been temporarily extracted means that the affected areas can be flooded with inert gases more quickly and more easily if the inert gases are able to expand into the partial vacuum. The fire-suppressing or fire-preventing effect of the inert gases is enhanced or also accelerated thereby.

In a further preferred embodiment of the invention, the features of which may also be combined with features of other embodiments, provision is made to introduce at least one inert gas in liquid form, or to maintain at least one inert gas for introduction in liquid form. Such embodiments also offer a further advantage due to the cooling effect created by the evaporation of the preferably volatile liquid inert gases, particularly if the latent heat of the phase transition underlying the evaporation is a high as possible. The one or more inert gases in liquid form are preferably injected in combination with a prior extraction of gases in the interior, on the surface, or in the surroundings of the electrochemical energy store. This approach requires that the injection of inert gases in liquid form into the area to be protected be highly effective, because the prevailing negative pressure helps the inert gases to spread and evaporate.

In a further preferred embodiment of the invention, the features of which may also be combined with features of other embodiments, it is provided that the predefined concentration value of an inert gas or mixture of inert gases is determined or modified depending on a temperature measured in the interior, on the surface, or in the surroundings of the electrochemical energy store.

In a further preferred embodiment of the invention, the features of which may also be combined with features of other embodiments, it is provided that the predefined concentration value of an inert gas or mixture of inert gases is determined or modified depending on a substance concentration measured or observed in the interior, on the surface, or in the surroundings of the electrochemical energy store. Preferred substances, whose concentrations are measured or observed in this context are potential educts (reaction participants) of fire-promoting chemical reactions.

In the following, the present invention will be described in greater detail on the basis of preferred embodiments thereof and with reference to the drawing.

In the drawing:

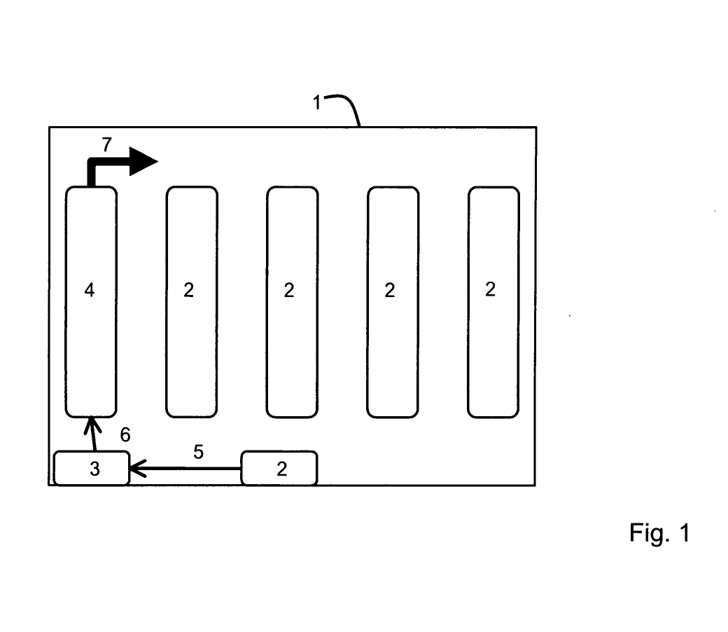

FIG. 1 is a diagrammatic representation of a first preferred embodiment of the invention;

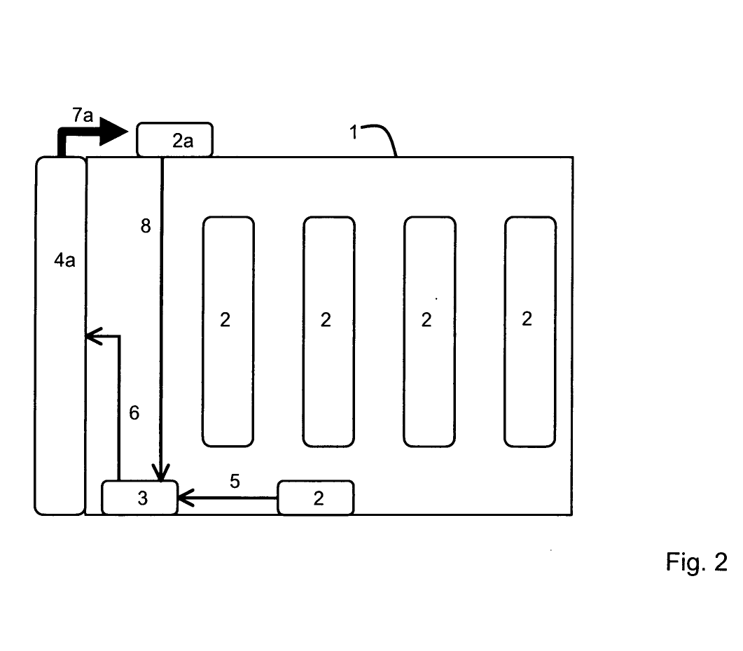

FIG. 2 is a diagrammatic representation of a second preferred embodiment of the invention;

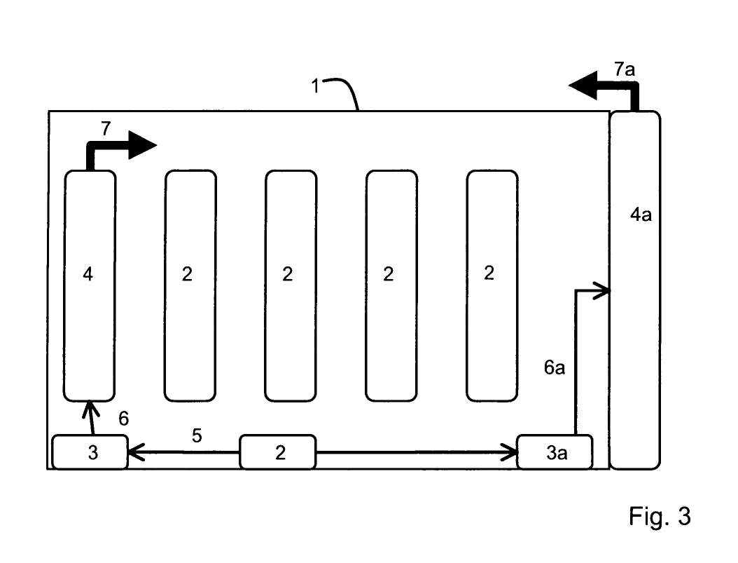

FIG. 3 is a diagrammatic representation of a third preferred embodiment of the invention; and

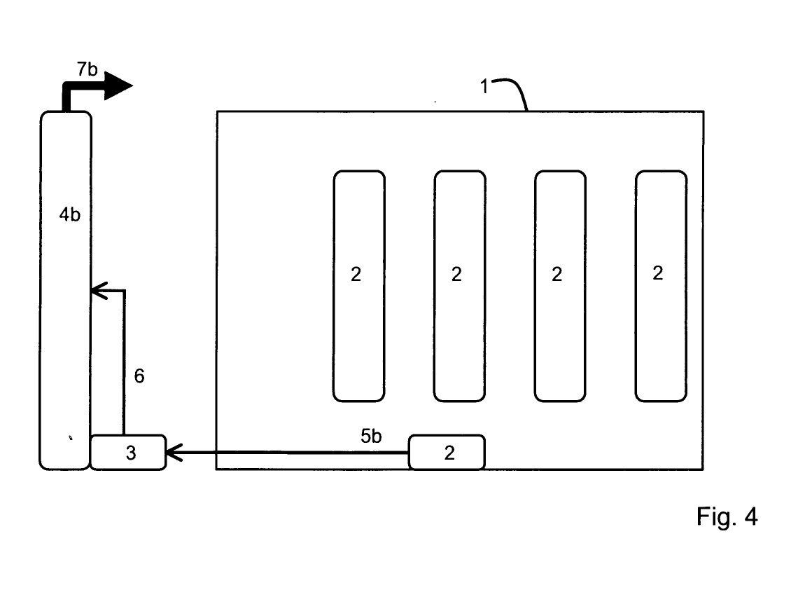

FIG. 4 is a diagrammatic representation of a fourth preferred embodiment of the invention.

The embodiment of an electrochemical energy store according to the invention represented diagrammatically in FIG. 1 comprises a plurality of galvanic elements 2 in a housing 1 and a sensor 2, from which the measurement results 5 are forwarded to a control unit 3, which in turn sends control signals 6 to a gas supply device 4 in order to control said supply device on the basis of the measured sensor data.

The gas supply device preferably also comprises a gas reservoir. If this is not the case, the gas is supplied from the outside via a gas supply line that is not shown in the figures. Sensor 2 is preferably a gas sensor for measuring the concentration of an inert gas or multiple inert gases in housing 1. In other embodiments of the invention, it is also possible to provide a plurality of sensors, which may be different or some of which may be of the same kind, and which measure the same physical parameters, preferably gas concentrations or gas partial pressures, or different physical parameters such as the concentrations of inert gases, concentrations of reactants (inducts) of chemical reactions that may participate in the fire at various locations, or temperatures at various locations inside housing 1. On the basis of control signals 6, control unit 3 determines when and how gas supply device is to flood housing volume 7 with an inert gas or multiple inert gases.

The flooding of rooms with gases, preferably inert gases, may be carried out with “gases” in a liquid or gaseous aggregate state. If a gas is introduced in the liquid state, it may justifiably be described as a gas given the assumption that the liquids concerned are preferably readily volatile, and are converted to the gaseous aggregate state very quickly and completely, or at least substantially under the conditions that prevail (pressure, temperature and the like) during the flooding process.

If in this context substances are used that absorb substantial quantities of heat during the transition thereof from the liquid to the gas phase, this yields an advantage in that the cooling effect associated therewith serves as a further factor in suppressing or preventing fire in the affected areas by removing energy from the potential reaction participants in a chemical reaction that might trigger or sustain a fire, thereby possibly increasing significantly the activation energy required by such reactions.

In the embodiment of the invention represented in FIG. 2, gas supply device 4a is located on the external surface of housing 1, so that it is possible to flood 7a the area outside housing 1 with inert gases. To ensure that this flooding 7a can be controlled on the basis of measurement values, an additional sensor 2a is provided in the external area of housing 1, and the measurement data 8 from this sensor is transmitted to control device 3. Sensor 2, which in this embodiment is also present inside housing 1, serves to control a flooding operation of the interior of the housing, not shown in this figure, through a gas supply device mounted in the housing or through gas supply device 4a that is mounted on the outside, which would represent a corresponding capability to flood the interior of housing 1 with inert gases.

Such a combination of the capabilities of the embodiments of FIGS. 1 and 3 is illustrated in FIG. 3, wherein a gas supply device 4 is provided in the interior of housing 1 to ensure flooding 7 of the housing interior with inert gases, and a gas supply device 4a is also mounted on the exterior of the housing to ensure flooding 7a of the area outside the housing. In this case, gas supply devices 4 and 4a are controlled by control units 3 and 3a, which receive their measurement data from the single sensor device 2 shown in FIG. 3. Here too, depending on the circumstances of the application, it may be advantageous to provide a variant in which multiple sensor devices 2 are placed at various locations inside and outside the housing.

These embodiments particularly show how a fire in the interior, on the surface, or in the surroundings of an electrochemical energy store may be suppressed or prevented with means that are installed in or on the electrochemical energy store, and are thus easily interchangeable or replaceable together with said energy store. Regarding applications such as electric road vehicles, for which frequent changes or replacements of electrochemical energy stores are often planned, this represents an advantage.

On the other hand, FIG. 4 shows another embodiment of the invention, in which the gas supply device and the control unit are collocated outside housing 1. This embodiment illustrates the option for inert gas extinguishing systems in which the electrochemical energy store only accommodates the sensor device of the device according to the invention for regulating the inert gas concentration. In this example, the measurement data from the sensor device is transmitted from the interior of the housing to the preferably stationary extinguishing device, or to the control unit therefor, for further processing.

1-16. (canceled)

17. A method for fighting or preventing fires in the interior, on the surface, or in the surroundings of an electrochemical energy store, the method comprising:
providing a device that functions to ensure that the concentration of at least one inert gas or a mixture of inert gases does not fall below a predetermined value in the interior, on the surface or in the surroundings of an electrochemical energy store; and
generating or maintaining a negative pressure at least temporarily in the interior, on the surface, or in the surroundings of the electrochemical energy store by extracting gases, into which negative pressure at least one inert gas or mixture of inert gases injected in liquid form is able to expand by evaporation, absorbing heat.

18. The method according to claim 17, in which the device comprises:
at least one sensor that measures the concentration of at least one inert gas;
a control unit to which the values measured by the at least one sensor are transmitted; and
a gas supply device that is controlled by the control unit in its function of introducing a stream of inert gas or a mixture of inert gases in the interior, on the surface, or in the surroundings of the electrochemical energy store.

19. The method according to claim 17, wherein an inert gas from the group consisting of argon, nitrogen, carbon dioxide, or a mixture of at least two gases from this group, or a mixture of at least one gas from this group with at least one other gas, is used, and the concentration of at least one of these gases is measured.

20. The method according to claim 19, wherein the at least one other gas comprises at least one inert gas.

21. The method according to claim 17, wherein a flow of the gases is generated or maintained at least temporarily in the interior, on the surface, or in the surroundings of an electrochemical energy store and facilitates intermixing of these gases.

22. The method according to claim 17, wherein the predetermined concentration value of an inert gas or mixture of inert gases is determined or modified depending on a temperature measured in the interior, on the surface, or in the surroundings of the electrochemical energy store.

23. The method according to claim 17, wherein the predetermined concentration value of an inert gas or mixture of inert gases is determined or modified depending on a substance concentration measured or observed in the interior, on the surface, or in the surroundings of the electrochemical energy store.

24. A device for fighting or preventing fires in the interior, on the surface, or in the surroundings of an electrochemical energy store, comprising:
a device configured to ensure that the concentration of an inert gas or a mixture of inert gases does not fall below a predetermined value in the interior, on the surface or in the surroundings of an electrochemical energy store, wherein the device is configured such that a negative pressure is generated or maintained at least temporarily in the interior, on the surface, or in the surroundings of the electrochemical energy store by extracting gases, the device further configured such that at least one inert gas or mixture of inert gases is injected in liquid form into the negative pressure and is able to expand by evaporation, absorbing heat.

25. The device according to claim 24, further comprising:
at least one sensor that measures the concentration of at least one inert gas;
at least one control unit to which the values measured by the at least one sensor can be transmitted, and
a gas supply device that is configured to introduce a stream of inert gas or a mixture of inert gases in the interior, on the surface, or in the surroundings of the electrochemical energy store, controlled by the at least one control unit.

26. The device according to claim 24, wherein the device is configured such that an inert gas from the group consisting of argon, nitrogen, carbon dioxide, or a mixture of at least two gases from this group, or a mixture of at least one gas from this group with at least one other gas, is provided, and the concentration of at least one of these gases can be measured.

27. The device according to claim 26, wherein the at least one other gas comprises at least one inert gas.

28. The device according to claim 24, wherein the device is configured such that a flow of the gases can be generated or maintained at least temporarily in the interior, on the surface, or in the surroundings of the electrochemical energy store in order to facilitate intermixing of the gases.

29. The device according to claim 24, wherein the device is configured such that the predetermined concentration value of an inert gas or mixture of inert gases is determined or modified depending on a temperature measured in the interior, on the surface, or in the surroundings of the electrochemical energy store.

30. The device according to claim 24, wherein the device is configured such that the predetermined concentration value of an inert gas or mixture of inert gases is determined or modified depending on a substance concentration measured or observed in the interior, on the surface, or in the surroundings of the electrochemical energy store.
